(19) United States
(12) Patent Application Publication
(10) Pub. No.: US 2023/0153567 A1
(43) Pub. Date: May 18, 2023

(54) METHOD, APPARATUS, AND SYSTEM FOR DEEP LEARNING OF SPARSE SPATIAL DATA FUNCTIONS

(71) Applicant: HERE Global B.V., Eindhoven (NL)

(72) Inventor: Tero Juhani KESKI-VALKAMA, Geroldswil (CH)

(21) Appl. No.: 17/530,023

(22) Filed: Nov. 18, 2021

(51) Int. Cl. G06N 3/04; G06N 3/08; G06F 7/24

(52) U.S. Cl. CPC G06N 3/04; G06N 3/08; G06F 7/24

(57) ABSTRACT

An approach is provided for deep learning of sparse spatial data functions. The approach involves, for instance, creating a sort convolutional neural network (SortCNN) layer comprising a multi-head cross-attention layer and one or more convolutional neural network (CNN) layers. At least one attention head of the multi-head cross-attention layer is associated with at least one linear projection matrix that is trained to arrange and quantize an unsorted set of input entities (e.g., sparse data) along an axis of a query/key space into a soft sorted set of the input entities based on inducing points in the query/key space. The approach also involves projecting the soft sorted entities from the multi-head cross-attention layer through the CNN layers. The CNN layers learn one or more functions based on integrating information from the soft sorted entities as arranged and quantized by the at least one linear projection matrix.

### BACKGROUND

Mapping service providers are increasingly using machine learning models (e.g., deep neural network learning) to make inferences based on a spatial data (e.g., a road network made of multiple connected road segments, vehicle trajectory data, etc.). For many machine learning applications, these spatial data can be input to machine learning models (e.g., convolutional neural networks (CNNs)) to make predictions, classifications, etc. However, such input data often are sparse and contain many empty pixels or bins of data. As a result, service providers face significant technical challenges with respect to ensuring machine learning models (such as CNNs) do not miss feature relationships or correlations (e.g., spatial data functions) that may extend beyond the sizes of typical convolutional filters.

### SOME EXAMPLE EMBODIMENTS

Therefore, there is a need for a deep learning method for learning sparse spatial data functions in applications such as, but not limited to, digital map making from sparse geometric data.

According to one embodiment, a method comprises creating a sort convolutional neural network (SortCNN) layer comprising a multi-head cross-attention layer and one or more convolutional neural network (CNN) layers. At least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space. The method also comprises projecting the set of soft sorted entities from the multi-head cross-attention layer through the CNN layers. The CNN layers learn one or more functions based on integrating information from the set of soft sorted entities as arranged and quantized by the at least one linear projection matrix. In one embodiment, the SortCNN layer can be a component of an overall machine learning model architecture that learns the one or more functions.

According to another embodiment, an apparatus comprises at least one processor, and at least one memory including computer program code for one or more computer programs, the at least one memory and the computer program code configured to, with the at least one processor, cause, at least in part, the apparatus to create a sort convolutional neural network (SortCNN) layer comprising a multi-head cross-attention layer and one or more convolutional neural network (CNN) layers. At least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space. The apparatus is also caused to project the set of soft sorted entities from the multi-head cross-attention layer through the CNN layers. The CNN layers learn one or more functions based on integrating information from the set of soft sorted entities as arranged and quantized by the at least one linear projection matrix. In one embodiment, the SortCNN layer can be a component of an overall machine learning model architecture that learns the one or more functions.

According to another embodiment, a non-transitory computer-readable storage medium carries one or more sequences of one or more instructions which, when executed by one or more processors, cause, at least in part, an apparatus to create a sort convolutional neural network (SortCNN) layer comprising a multi-head cross-attention layer and one or more convolutional neural network (CNN) layers. At least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space. The apparatus is also caused to project the set of soft sorted entities from the multi-head cross-attention layer through the CNN layers. The CNN layers learn one or more functions based on integrating information from the set of soft sorted entities as arranged and quantized by the at least one linear projection matrix. In one embodiment, the SortCNN layer can be a component of an overall machine learning model architecture that learns the one or more functions.

According to another embodiment, an apparatus comprises means for creating a sort convolutional neural network (SortCNN) layer comprising a multi-head cross-attention layer and one or more convolutional neural network (CNN) layers. At least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space. The apparatus also comprises means for projecting the set of soft sorted entities from the multi-head cross-attention layer through the CNN layers. The CNN layers learn one or more functions based on integrating information from the set of soft sorted entities as arranged and quantized by the at least one linear projection matrix. In one embodiment, the SortCNN layer can be a component of an overall machine learning model architecture that learns the one or more functions.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, at least one service configured to perform any one method/process or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of deep learning of sparse spatial data functions, according to one embodiment;

FIG. 2 is a flowchart of a process for deep learning of spatial data functions, according to one embodiment;

FIG. 3 is a diagram of components of a SortCNN layer, according to embodiment;

FIG. 4 is a flowchart of a process for providing a learning linear projection matrix for deep learning of sparse spatial data functions, according to one embodiment;

FIG. 5 is a diagram of an example map-making pipeline incorporating use of a SortCNN layer, according to one embodiment;

FIG. 6 is a diagram of a geographic database, according to one embodiment;

FIG. 7 is a diagram of hardware that can be used to implement an embodiment of the processes described herein;

FIG. 8 is a diagram of a chip set that can be used to implement an embodiment of the processes described herein; and

FIG. 9 is a diagram of a terminal that can be used to implement an embodiment of the processes described herein.

### DESCRIPTION OF SOME EMBODIMENTS

Examples of a method, apparatus, and computer program for deep learning of sparse spatial data functions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

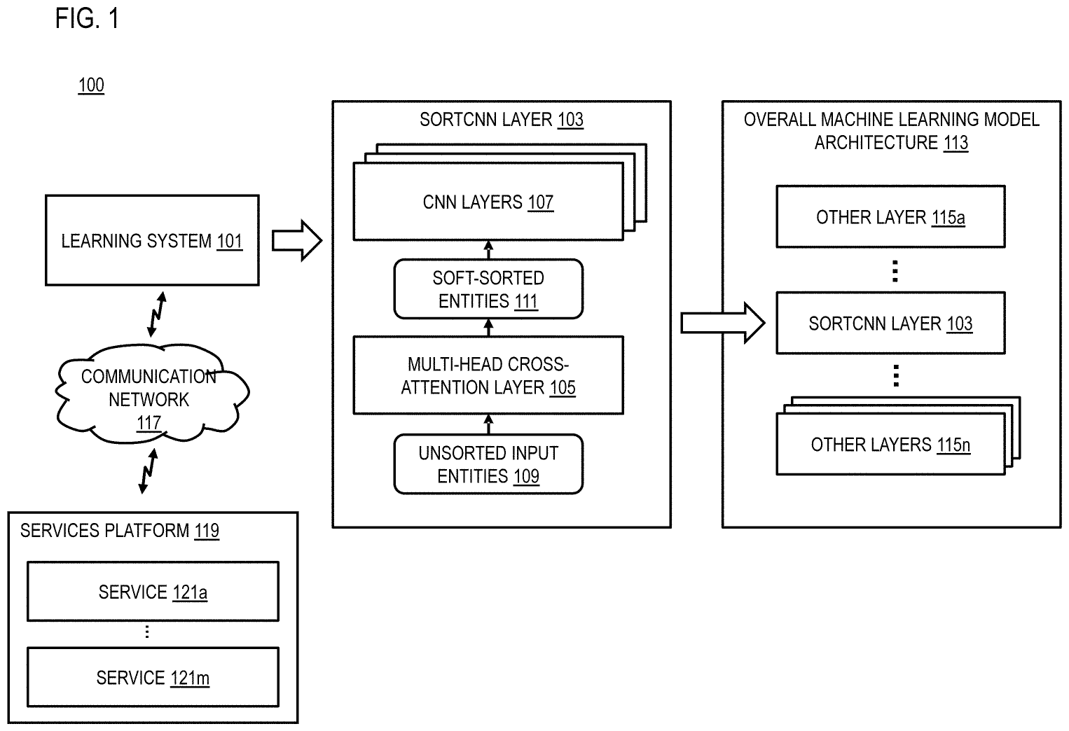

FIG. 1 is a diagram of a system capable of deep learning of sparse spatial data functions, according to one embodiment. Sparse spatial data representations form a problem for deep neural network learning. They are naturally at best in learning about dense representations such as rasterized images. Specifically sparse geometric data such as point sets (e.g., geographic coordinates corresponding to locations, trajectories, cartographic/map features, etc.) and multi-lines in vector graphic-like representations (e.g., representing road networks, geographic areas, terrain features, etc.) are inherently challenging for deep neural networks (e.g., convolutional neural networks (CNNs)).

In map-making and logistics, and more generally location data, there is often an abundance of sparse spatial data such as lists of point locations.

Because of limitations of traditional CNNs, the data which is collected and is represented as sparse geometries cannot readily be used to train deep neural network models to model functional relationships in those domains. These sparse spatial data functions include but are not limited to:
Learning to extract road geometries from position trajectories;
Learning to extract intents from position trajectories;
Learning to forecast the future traffic jams from position trajectories; and
Learning to classify point-of-interests from contextual data from existing vector maps and/or position trajectories.

Generally, traditional methods handle sparse geometrical data in neural networks, for example, by rasterizing them on 2D images. This approach does not scale to more than 2 dimensions well, and can potentially lose valuable information in projection. Alternatively, the sparse data can be used as-is, but the existing methods are unable to utilize such data representations efficiently in neural network learning (e.g., particularly with a traditional CNN). For example, due to its inherent functioning, an individual convolutional layer is only capable of capturing spatial correlations in the immediate spatial neighborhood of certain input values (e.g., pixel values in an image). In order to detect and utilize patterns which involve more distant sets of values (e.g., such as in the case of sparse spatial data), CNNs typically consist of multiple stacked convolutional layers (which however increases computational cost as well as the risk of overfitting to the training data or limiting the convolutional filter kernel width that can be used).

One traditional approach for capturing spatial correlations in sparse graph networks are Graph Neural Networks (GNN) and in particular Graph Convolutional Neural Networks (GCNN). Rather than applying trainable filters to the spatial neighborhood of each pixel of an input image as in the case of CNN, GCNN perform similar operations on the nodes or edges of a graph, thereby defining their respective neighborhoods based on the topology of the graph. Comparable to the stacked layers approach described, multiple steps of processing are needed in GCNN in order to capture longer distance correlations beyond the immediate neighborhood of a node or edge. Also, the message passing mechanism between nodes and/or edges is entirely determined by the graph topology, thereby not taking into account any correlation patterns of observed phenomena on the network. A general disadvantage of GCNN compared to CNN, however, is their relatively higher complexity and computational cost.

To address these technical challenges, the system 100 of FIG. 1 introduces a capability to synergistically use attentional and convolutional approaches in combination to enable learning of sparse spatial data functions. In other words, the various embodiments described herein are not purely convolution-based, as it is based on a synergistic use of both attentional and convolutional methods together, and can be described as “Attentional Convolutional Methods.”

In particular, the system 100 includes a neural architecture which is able to efficiently learn to input and/or output sparse spatial representations. In one embodiment, the system 100 has a learning system 101 that can create or otherwise use a novel component referred to herein as a “Sort Convolutional Neural Network (SortCNN) layer” (e.g., SortCNN layer 103 as shown in FIG. 1) which includes attentional components (e.g., a multi-head cross-attention layer 105 in combination with one or more CNN layers 107 which enables CNN layers 107 to be used on unordered sets of sparse entity representations (e.g., unsorted input entities 109). In one embodiment, the multi-head cross-attention layer 105 of SortCNN layer 103 “soft sorts” the unsorted input entities along one or more learnable quantization axes (e.g., an axis in a query/key space) so that entities that are more similar in the query/key space are weighted more closely in the attentional outputs (e.g., soft-sorted entities 111).

In one embodiment, the soft-sorted entities 111 (e.g., output entities of the multi-head cross-attention layer 105) are weighted linear combinations of the unsorted input entities 109, so the soft-sorted entities 111 do not necessarily corresponding one-to-one to the unsorted input entities 109 as would be the case in if a traditional sort algorithm were used. Hence, this is why the arrangement and quantization of the unsorted input entities 109 performed by the SortCNN layer 103 is referred to herein as a “soft sort” as opposed to a traditional sort. The soft-sorted entities 111 are then projected through the CNN layers 107 to learn one or more sparse spatial functions. By way of example, a CNN is a particular type of neural network where—in contrast to fully connected networks—one or more convolutional layers extract patterns of increasing complexity by convolving the values in the neighborhood of an input value or output of a previous hidden layer (e.g., with the neighborhood size defined by the shape and/or size of the convolutional filter that is used).

In one embodiment, the system 100 also defines an overall architecture (e.g., an overall machine learning (ML) model architecture 113 which utilizes one or more of the SortCNN layers 103 and other attentional mechanisms and/or other ML layers 115a-115n (also referred to as other layers 115) describe an ML model which is able to learn many tasks in sparse spatial representations input and/or output domains.

By way of example, this overall ML model architecture 113 can be used in various use cases such as but not limited to:
Producing vector maps based on collected real world location data; and
Filtering, smoothing, and cleaning up location data and position trajectories.

In one embodiment, the implement these use cases, the overall ML model architecture 113 can be connected (e.g., overall a communication network 117) or otherwise incorporated into a services platform 119 and/or one or more services 121a-121m (also collectively referred to as services 121) that use the output of the overall ML model architecture 113 to perform various functions. Examples of these functions include but are not limited to map-making, navigation, other location-based services, and/or any other function that relies on sparse spatial data functions (or sparse date more generally including non-spatial sparse data).

The advantage of this method is that sparse geometric representations can be directly learned from and to, using powerful deep learning models, without rasterizing them into images.

One example use case of the various embodiments described herein includes, but is not limited to, deep learning for three-dimensional (3D) point clouds. For example, in one embodiment, the various embodiments described herein can be used for point cloud 3D shape classification by, for instance, removing the decoder stack in the corresponding overall ML model architecture 113 and replacing it with a simpler set of layers producing a single output for point cloud category. However, the various embodiments described herein are more general than this particular example, and can handle not only 3D point clouds, but any sparse geometric entity representations.

In another example use case, the various embodiments described herein can also be used for 3D point cloud segmentation, for instance, by using a special output layer after the decoder stack output which would attend to the output entities from the input entities and produce a category for each point. However, as in the example above, the various embodiments described herein are more general than this, and can also produce novel sets of geometric sparse entities from point clouds or other kinds of sets of sparse geometric entities. In effect, the various embodiments described herein can map from point clouds to point clouds, or from point sets to point sets, but is not limited to points as geometric entities.

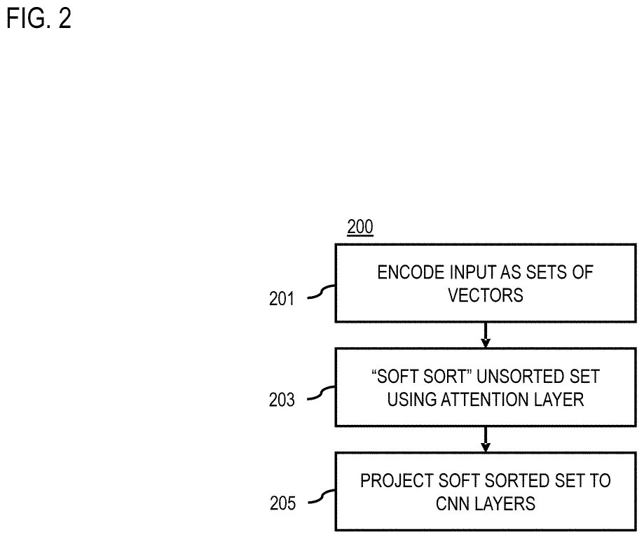

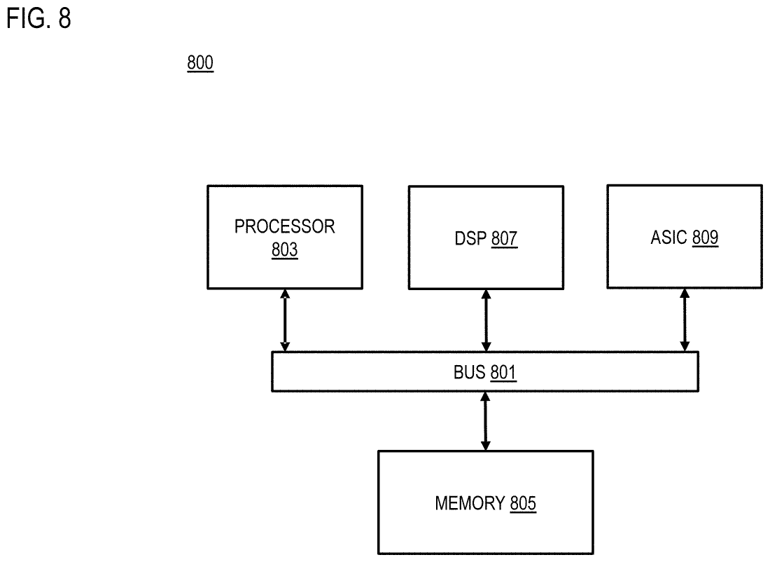

FIG. 2 is a flowchart of a process for deep learning of spatial data functions, according to one embodiment. In various embodiments, the learning system 101 or any equivalent system capable of creating ML models and architectures may perform one or more portions of the process 200 and may be implemented in, for instance, a chip set including a processor and a memory as shown in FIG. 8. As such, the learning system 101 can provide means for accomplishing various parts of the process 200, as well as means for accomplishing embodiments of other processes described herein in conjunction with other components of the system 100. Although the process 200 is illustrated and described as a sequence of steps, it is contemplated that various embodiments of the process 200 may be performed in any order or combination and need not include all of the illustrated steps

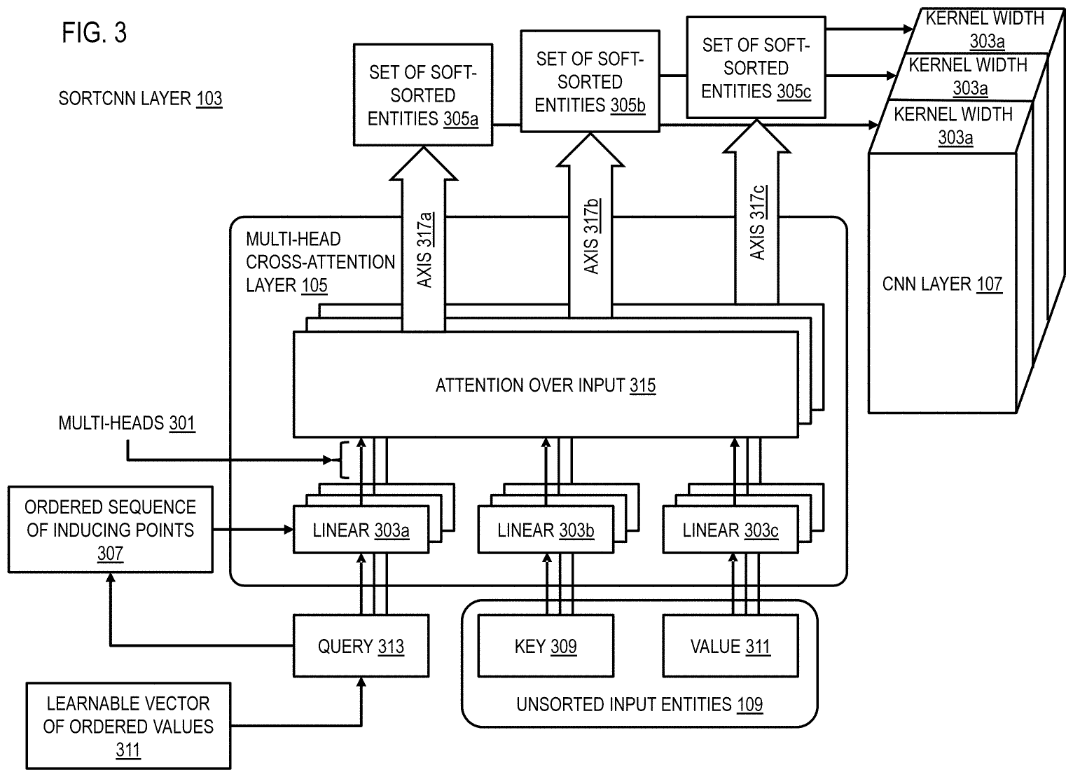

In one embodiment, the main component of the system 100 is the SortCNN layer 103. As discussed above, this layer 103 is composed of a multi-head cross-attention layer 105 and a sequence of CNN layers 107 which can have kernel width larger than 1. Accordingly, the learning system creates a SortCNN layer 103 comprising a multi-head cross-attention layer 105 and one or more CNN layers 107. As shown in the example SortCNN layer 103 of FIG. 3, in one embodiment, at least one attention head (e.g., one head of the three multi-heads 301 illustrated in FIG. 3) the of the multi-head cross-attention layer 105 is associated with at least one linear projection matrix (e.g., one linear projection matrix 303a of various linear projection matrices 303a-303c—also collectively referred to as linear projection matrices 303) that is trained to arrange and quantize an unsorted set of input entities 109 along an axis of a query/key space into a soft sorted set of the input entities (e.g., soft-sorted entities 111 that are illustrated in FIG. 3 as sets of soft-sorted output entities 305a-305c—also collectively referred to as sets of soft-sorted entities 305) based on one or more inducing points (e.g., ordered sequence of inducing points 307) in the query/key space.

The multi-head cross-attention layer 105 takes in, for instance, a set of entities (e.g., unsorted input entities 109). In step 201, the unsorted input entities 109 are encoded as sets of vectors for input to the heads 315 of the multi-head cross-attention layer 105). Each of the entities is an associated with key 309 and corresponding value 311 of the key 309), and a set of queries 313 (e.g., for selecting or matching entities based on key/value pair). Then, in one embodiment, each input vector corresponds to each input entity, and each element of the vector corresponds to a respective key/value pair for each input entity. The multi-head cross-attention layer 105 outputs as many entities as there are queries in each set of output entities 305. Each set of output entities 305, for instance, includes an output entity for each query so that these output entities are a weighted linear combination of the input entities weighted so that the entities where the keys 309 match the queries 313 the best are weighted the highest (e.g., with respect to computed attention over input 315—e.g., attention score based weighted sum of projected input entities for each query and head 315). Very typically, the entity and the corresponding key values are produced by learnable projections from the entity values. In other words, the multi-head cross-attention layer takes in the input entities and one or more queries to generate an output entity for each query of the one or more queries. The output entity is, for instance, a weighted linear combination of the input entities based on a matching of one or more keys of the input entities to each query.

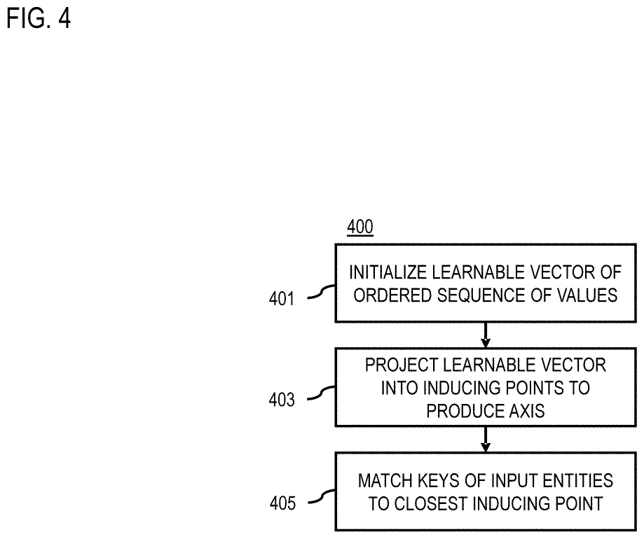

In one embodiment of the SortCNN layer 103, the queries 313 are taken for this cross-attention from an ordered sequence of values. For example, the multi-head cross-attention layer 105 takes the queries from a trainable, ordered sequence of inducing points 307, as described in the process 400 of FIG. 4 for training the linear projection matrix, according to one embodiment. In step 401, a learnable vector 311 is initialized as an ordered sequence of values (e.g., floating-point values), for example, from 0 to n, where n is the length of the vector corresponding to the number of queries 313. The number n is also the number of entities to produce as layer output (e.g., produced each set of soft-sorted entities 305). This is because each query 313 respectively produces an output entity. The number n can be a constant, or it can be computed based on the number of input entities 109 and be relative to that number.

In step 403, the learnable vector 311 is projected to produce queries 313 for each of the one or more heads 301 of the multi-head cross-attention layer 105. For each head 301, there is a learnable linear projection matrix 303, which projects the ordered sequence of values (e.g., the learnable vector 311) into inducing points 307 in k-dimensional space, where k is the dimensionality of the keys 309 and queries 313. This produces an axis (e.g., axis 317a-317c—also collectively referred axes 317) in the query/key space corresponding to each head 301, which is then used to match to keys 309 to pick entities (e.g., from among the input entities 109) with associated keys 309 closest to an inducing point 307 (step 405). This process approximately “soft sorts” the input entities 109 according to a learnable axis 317 and its quantization (step 203). In other words, the dimensionality of the query/key space is based on a dimensionality of the one or more queries and the one or more keys of the input entities. An axis 317 then corresponds to one dimension of the query/key space. As discussed above, the output entities (e.g., in each set of soft-sorted entities 305) are weighted linear combinations of the input entities 109, and so do not necessarily correspond one-to-one to the input entities 109 as would be the case if a traditional sort algorithm was used (thus use of the “soft sort” label).

In one embodiment, when more than one attentional head is used in the multi-head cross-attention layer 105, the SortCNN layer 103 learns multiple quantization axes 317 and their respective inducing points 307. The output of this multi-head cross-attentional layer 105 then becomes composed of the input entities 109 that are “soft sorted” along multiple independent quantization axes 317 into respective sets of soft-sorted entities 305.

The reason for learning a “soft sort” quantization of originally unordered input entities 109 is that it now enables the use of CNN layers 107 with kernel width larger than one. That is because when the input entities 109 have been attentionally “soft sorted,” the neighborhoods of the entities in the output (e.g., each set of soft-sorted entities 305) are now meaningful such that neighbor entities in the output resemble each other with in the sense of the sort axes 317. As result, each set of sort-sorted entities 305 can be projected into respective kernel widths 319a-319c (also collectively referred to as kernel widths) of a CNN layer 107. So, the cross-attentional output becomes an input to a stack of normal CNN layers 107 that can have kernel widths greater than 1, which can be set up to produce as many entities as there are outputs of the cross-attentional layer 105 using input padding appropriately.

Returning to the process 200 of FIG. 2, in step 205, the learning system 101 projects the set of soft sorted entities 305 from the multi-head cross-attention layer 105 through the CNN layers 107. In other words, the SortCNN layer 103 therefore takes in input of unsorted entities, “soft sorts” these across several learnable quantization axes, and projects those through CNN layers which can learn functions which require integrating together information from point neighbors.

As discussed with respect to FIG. 1, in one embodiment, one or more SortCNN layers 103 can be used as components in an overall ML model architecture 113. In one example use case, the overall ML model architecture 113 takes in geometric entities as inputs, which can be for example point coordinates in 2D, 3D, or arbitrary dimensional space, along with any extra information available about those points such as, but not limited to, orientation, speed, color, category, and/or the like. The overall ML model architecture 113 outputs new geometric entities, such as points or lines with possibly extra information attached such as but not limited to category. Generally, in this embodiment, the overall ML model architecture 113 could be called point set to point set model in its simple form.

In one embodiment, the overall ML model architecture can be composed of tiers where each tier has a corresponding encoder and decoder layers (e.g., corresponding to the SortCNN layer 103 and/or other layers 115 of the architecture 113) connected together with optional skip connections (e.g., connections that provide an alternative path for the gradient with backpropagation to enable one or more layers of the architecture 113 to be bypassed).

Alternatively, in one embodiment, the overall ML model architecture can be composed of an encoder stack and a decoder stack. For example, the decoder stack produces model outputs, and can optionally include an extra projection layer after the ultimate decoder output to project that output into the form required in the task, or attend with a cross-attention layer to the output entities queried by the input entities to produce output entities which associate to the specific input entities.

In one embodiment, each encoder layer can be composed of a sequence of layers, from input to output (the illustrated order of the layers is provided as just one presented alternative and is not intended as a limitation, the order can be arbitrary). An example sequence includes but is not limited to the following:
One or more single- or multi-head self-attention layers;
A SortCNN layer 103; and
One or more entity-wise dense layers

The layers, for instance, can use any activation function. One example activation function includes but is not limited to ReLu. In one embodiment, any number of attention heads (e.g., four attention heads) can be used for the self-attention layer. Self-attention layer entity projections, for instance, can be initialized with an identity matrix to facilitate faster learning. In addition, a residual connection can be used from the Entity-wise Dense Layer inputs to outputs to facilitate faster learning.

In one embodiment, each decoder layer can be composed of a sequence of layers from input to output (the illustrated order of the layers is provided as just one presented alternative and is not intended as a limitation, the order can be arbitrary). An example sequence uses an inverse order compared to the corresponding encoder layer as follows:
One or more entity-wise dense layers;
A SortCNN layer 103; and
A cross-attention layer where the queries are from the corresponding encoder layer inputs with an optional learnable projection function, and the entities and keys are from the decoder SortCNN layer outputs. The entities(1) are the SortCNN layer output entities optionally projected through a learnable projection, and the keys are the same SortCNN layer output entities optionally projected through a different learnable projection, so the keys and the entities are intrinsically tied together as is a common pattern in self- or cross-attention layers. The attended entities(1) can optionally be concatenated with the entities from the encoder stack output entities, optionally projected through a learnable transformation to produce a concatenated entity skip connection which we have found to be useful structure.

In one embodiment, the query connections and the skip connections from the encoder side to the decoder side optionally can be both projected through separate SortCNN layers 103.

In one embodiment, the concatenated entity skip connection can be used to match with attentional models. Typically, skip/residual connections would be summed with the corresponding entities rather than concatenated as in this embodiment. This concatenation provides a unique application in attentional models. In addition, the concatenation is performed entity-wise, and not channel-wise as may be conventionally performed.

In one embodiment of the overall ML model architecture 113, each encoder layer output goes to the subsequent encoder layer input. The final encoder layer output is connected to the corresponding decoder layer input. The decoder layer outputs are sequentially connected to next decoder layer inputs, until finally they produce model output, which can optionally be further projected as per task.

For the use case where the inputs of the model are observed points in the real world with approximate locations collected from multiple sources and over different times, and the outputs are the correct locations of these observed objects on a map, the learning system 101 simply feeds the input observation locations to this overall ML model architecture 113 as inputs, and train it to approximate the ground truth of known locations of mapped objects such as, but not limited to, traffic signs or road lines. This model is able to “conflate” new entities into model outputs which do not have corresponding one-to-one relationship to measured input entities. The overall ML model architecture 113 (in this embodiment) is therefore able to learn to generate, e.g., unobserved road line segments based on actually observed road line segments around the hypothetical, “conflated” segment, which would imply the “conflated” segment would likely exist in the ground truth even if not observed.

In one embodiment, the loss function for training the overall ML model architecture 113 is arbitrary. One example of the loss function includes, but is not limited to, a Chamfer distance to measure the distance between the output point set and the ground truth point set. Chamfer loss is insensitive to cardinalities.

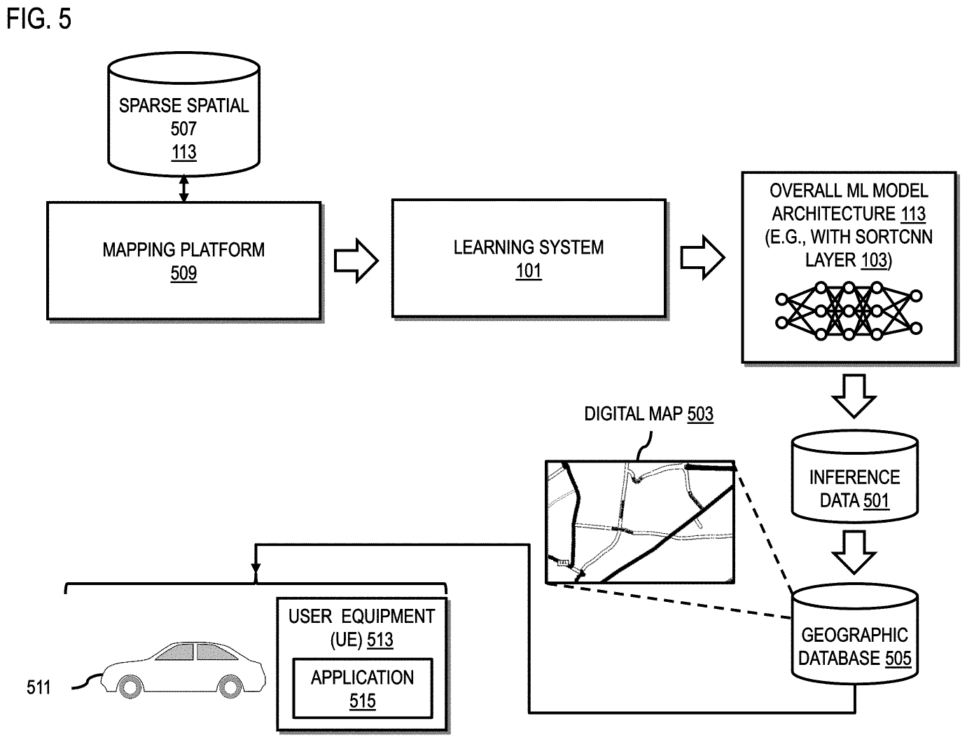

In one embodiment, as shown in the example map-making pipeline of FIG. 5, the outputs (e.g., inference data 501) of the overall ML model architecture 113 (e.g., incorporating at least one SortCNN layer 103 according to the embodiments described herein) can ultimately be used to produce maps (e.g., digital map data 503 of a geographic database 505) based on sparse spatial data 507 (e.g., point features observed in the real world). By way of example, a mapping platform 509 collects the sparse spatial data 507 transmits the data to the learning system 101. The learning system 101 processes the sparse spatial data as input to the overall ML model architecture 113. The overall ML model architecture 113 is constructed to include at least one SortCNN layer 103 to make inferences (e.g., inference data 501) indicating the ground truth locations of observed point location of map features). In one embodiment, because the model outputs (e.g., inference data 501) are not sensitive to entity cardinality, and thus is liable to produce multiple similar duplicate entity outputs where only a single entity output is desired, the learning system 101 and/or the mapping platform 509 can run a clustering algorithm or some other duplicate removal/filtering for the model outputs (e.g., inference data 501) to only leave single entities at specific points on the map. The mapping can then use the model outputs to populate a geographic database 505 with a resulting digital map 503. The geographic database 505 can then be provided to end user devices (e.g., vehicles 511 and/or user equipment (UE) devices 513) executing mapping and/or other location-based applications 515 that rely on the digital map data 503 of the geographic database 505.

Returning to FIG. 1, as shown, the system 100 includes a learning system 101 for deep learning of sparse spatial data functions. In one embodiment, the learning system 101 includes or is otherwise associated with one or more SortCNN layers 103 and/or machine learning models (e.g., based on the overall ML model architecture 113 and/or other neural networks including at least one SortCNN layer 103) for performing ML tasks relying on sparse spatial data according to the embodiments described herein.

In one embodiment, the learning system 101 has connectivity over the communication network 117 to the services platform 119 that provides one or more services 121 that can use the sparse spatial data functions enabled by the SortCNN layer 103 to perform one or more functions. By way of example, the services 121 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 121 uses the output of the SortCNN layer 103 and/or ML models incorporating the SortCNN layer 103 (e.g., the overall ML model architecture 113) to provide services 121 such as navigation, mapping, other location-based services, etc. to the vehicles 511, UEs 513, and/or applications 515 executing on the UEs 513.

In one embodiment, the learning system 101 may be a platform with multiple interconnected components. The learning system 101 may include multiple servers, intelligent networking devices, computing devices, components, and corresponding software for combining location data sources according to the various embodiments described herein. In addition, it is noted that the learning system 101 may be a separate entity of the system 100 or part of any other component of the system 100.

In one embodiment, the vehicles 511 and/or UEs 513 may execute software applications 515 to outputs generated by the SortCNN layer 103 and/or any other ML model incorporating the SortCNN layer 103 according to the embodiments described herein. By way of example, the applications 515 may also be any type of application that is executable on the vehicles 511 and/or UEs 513, such as autonomous driving applications, routing applications, mapping applications, location-based service applications, navigation applications, device control applications, content provisioning services, camera/imaging application, media player applications, social networking applications, calendar applications, and the like. In one embodiment, the applications 515 may act as a client for the learning system 101 and perform one or more functions associated with compressing data for machine learning or equivalent tasks alone or in combination with the learning system 101.

By way of example, the vehicles 511 and/or UEs 513 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 511 and/or UEs 513 can support any type of interface to the user (such as “wearable” circuitry, etc.). In one embodiment, the vehicles 511 and/or UEs 513 may be associated with or be a component of a vehicle or any other device.

In one embodiment, the vehicles 511 and/or UEs 513 are configured with various sensors for generating or collecting sparse spatial data (e.g., location data points or coordinates), related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 505. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 511 and/or UEs 513 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 511 and/or UEs 513 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 511 and/or UEs 513 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 117 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the components of the system 100 communicate with each other and other components using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

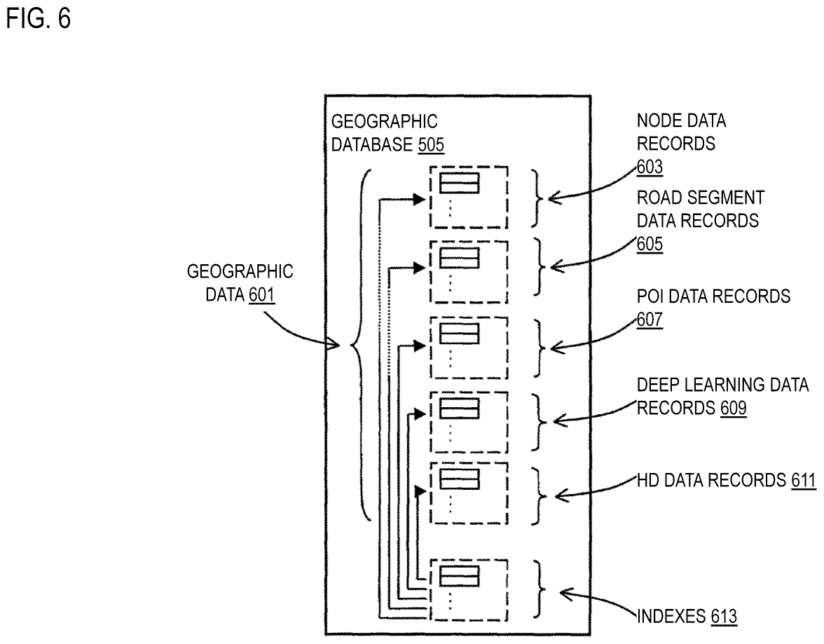

FIG. 6 is a diagram of a geographic database 505, according to one embodiment. In one embodiment, the geographic database 505 includes geographic data 601 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 601. In one embodiment, the geographic database 505 include high definition (HD) mapping data that provide centimeter-level or better accuracy of map features. For example, the geographic database 505 can be based on Light Detection and Ranging (LiDAR) or equivalent technology to collect billions of 3D points and model road surfaces and other map features down to the number lanes and their widths. In one embodiment, the HD mapping data (e.g., HD data records 611) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 505.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 505 follows certain conventions. For example, links do not cross themselves and do not cross each other except at a node. Also, there are no duplicated shape points, nodes, or links. Two links that connect each other have a common node. In the geographic database 505, overlapping geographic features are represented by overlapping polygons. When polygons overlap, the boundary of one polygon crosses the boundary of the other polygon. In the geographic database 505, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 505 includes node data records 603, road segment or link data records 605, POI data records 607, deep learning data records 609, HD mapping data records 611, and indexes 613, for example. More, fewer, or different data records can be provided. In one embodiment, additional data records (not shown) can include cartographic (“carto”) data records, routing data, and maneuver data. In one embodiment, the indexes 613 may improve the speed of data retrieval operations in the geographic database 505. In one embodiment, the indexes 613 may be used to quickly locate data without having to search every row in the geographic database 505 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (for example, representing intersections or an end of a road) corresponding to the respective links or segments of the road segment data records 605. The road link data records 605 and the node data records 603 represent a road network, such as used by vehicles, cars, and/or other entities. Alternatively, the geographic database 505 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 505 can include data about the POIs and their respective locations in the POI data records 607. The geographic database 505 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 505 can also include deep learning data records 1009 for storing data associated with deep learning of sparse spatial data including but not limited to unsorted input entities 109, soft-sorted entities 111, SortCNN layers 103, overall ML model architectures 113, and/or any other related data that is used or generated according to the embodiments described herein.

In one embodiment, as discussed above, the HD mapping data records 611 model road surfaces and other map features to centimeter-level or better accuracy. The HD mapping data records 611 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 611 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 611.

In one embodiment, the HD mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 505 can be maintained by the content provider 127 in association with the services platform 119 (e.g., a map developer). The map developer can collect geographic data to generate and enhance the geographic database 505. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 505 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles 511 and/or UEs 513. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing deep learning of sparse spatial data functions may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

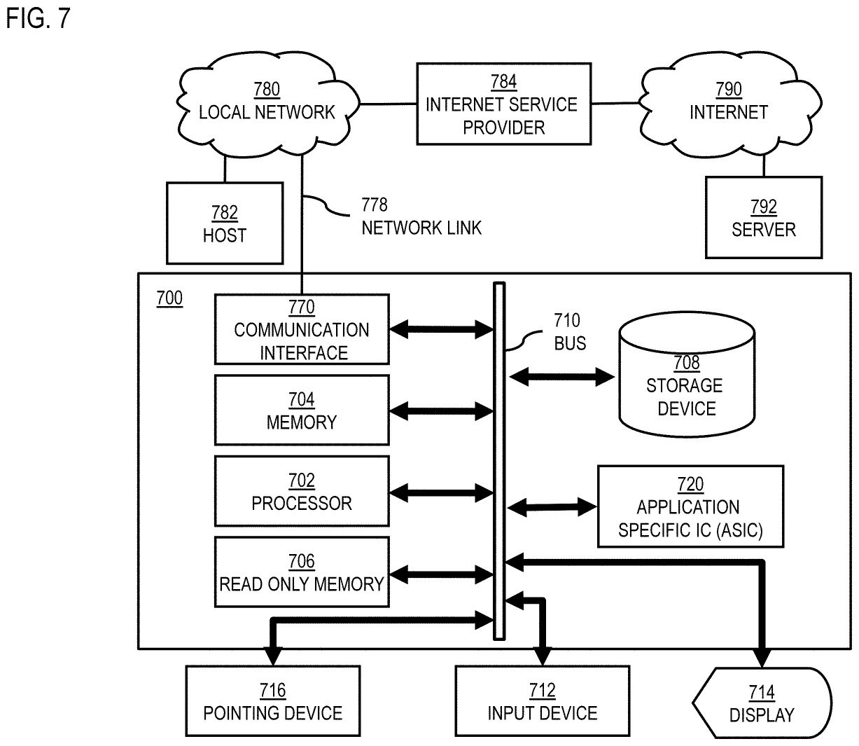

FIG. 7 illustrates a computer system 700 upon which an embodiment of the invention may be implemented. Computer system 700 is programmed (e.g., via computer program code or instructions) to provide deep learning of sparse spatial data functions as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing deep learning of sparse spatial data functions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing deep learning of sparse spatial data functions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing deep learning of sparse spatial data functions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 117 for providing deep learning of sparse spatial data functions.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to providing deep learning of sparse spatial data functions as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to providing deep learning of sparse spatial data functions. The memory 805 also stores the data associated with or generated by the execution of the inventive steps.

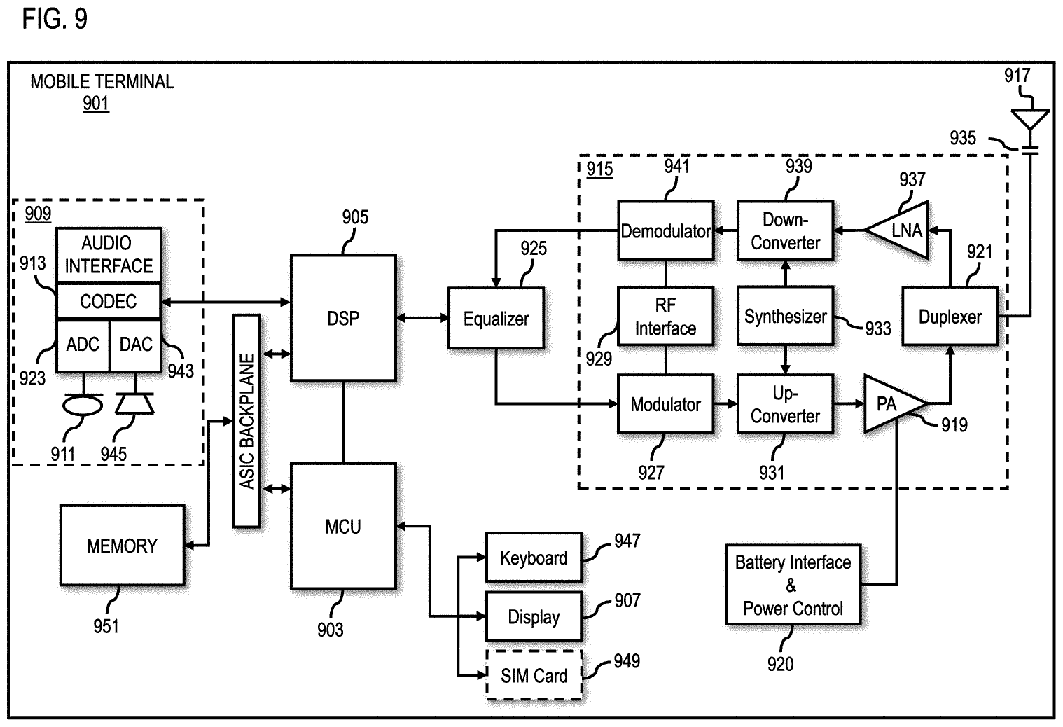

FIG. 9 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide deep learning of sparse spatial data functions. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
creating a sort convolutional neural network (SortCNN) layer comprising a multi-head cross-attention layer and one or more convolutional neural network (CNN) layers, wherein at least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space; and
projecting the set of soft sorted entities from the multi-head cross-attention layer through the CNN layers,
wherein the CNN layers learn one or more functions based on integrating information from the set of soft sorted entities as arranged and quantized by the at least one linear projection matrix.

2. The method of claim 1, wherein the multi-head cross-attention layer takes in the input entities and one or more queries to generate an output entity for each query of the one or more queries, and wherein the output entity is a weighted linear combination of the input entities based on a matching of one or more keys of the input entities to each query.

3. The method of claim 2, wherein a dimensionality of the query/key space is based on a dimensionality of the one or more queries and the one or more keys of the input entities, and wherein the axis corresponds to one dimension of the query/key space.

4. The method of claim 1, wherein a training of the at least one linear projection matrix comprises:
initializing a learnable vector as an ordered sequence of values, wherein a number of elements in the ordered sequence of values corresponds to a number of queries to input in the multi-head cross attention layer; and
projecting the learnable vector into the one or more inducing points in the query/key space to produce the axis of the query/key space,
wherein the axis is used to match one or more keys of the input entities with one or more inducing point keys of a closest inducing point of the one or more inducing points to arrange and quantize the input entities along the axis.

5. The method of claim 1, wherein the SortCNN layer is a component of an overall machine learning model architecture.

6. The method of claim 5, wherein the input entities of the overall machine learning model architecture include a first geometric entity, and wherein an output of the overall machine learning model is a second geometric entity.

7. The method of claim 6, wherein the first geometric entity includes a set of point coordinates in an arbitrary dimensional space; and wherein the second geometric entity comprises a point, a line, a shape, or a combination thereof.

8. The method of claim 5, wherein the overall machine learning model architecture comprises one or more tiers of an encoder layer and a decoder layer.

9. The method of claim 8, wherein the encoder layer and the decoder layer are connected with a skip connection.

10. The method of claim 5, wherein the overall machine learning model architecture comprises at least the SortCNN layer followed by another cross-attention layer, and wherein one or more attended entities of the SortCNN layer are concatenated with one or more output entities of the another cross-attention layer.

11. The method of claim 10, wherein the one or more attended entities of the SortCNN layer are concatenated with one or more output entities of the another cross-attention layer using a learnable transformation.

12. The method of claim 5, wherein the input entities of the overall machine learning model architecture include one or more observed points with approximate locations, and wherein an output of the overall machine learning model is an approximate ground truth location of a map feature.

13. The method of claim 12, wherein a loss function of the overall machine learning model architecture includes a Chamfer distance.

14. An apparatus comprising:
at least one processor; and
at least one memory including computer program code for one or more programs,
the at least one memory and the computer program code configured to, within the at least one processor, cause the apparatus to perform at least the following,
create a sort convolutional neural network (SortCNN) layer comprising a multi-head cross-attention layer and one or more convolutional neural network (CNN) layers, wherein at least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space; and
project the set of soft sorted entities from the multi-head cross-attention layer through the CNN layers,
wherein the CNN layers learn one or more functions based on integrating information from the set of soft sorted entities as arranged and quantized by the at least one linear projection matrix.

15. The apparatus of claim 14, wherein the multi-head cross-attention layer takes in the input entities and one or more queries to generate an output entity for each query of the one or more queries, and wherein the output entity is a weighted linear combination of the input entities based on a matching of one or more keys of the input entities to each query.

16. The apparatus of claim 15, wherein a dimensionality of the query/key space is based on a dimensionality of the one or more queries and the one or more keys of the input entities, and wherein the axis corresponds to one dimension of the query/key space.

17. The apparatus of claim 14, wherein a training of the at least one linear projection matrix causes the apparatus to:
initialize a learnable vector as an ordered sequence of values, wherein a number of elements in the ordered sequence of values corresponds to a number of queries to input in the multi-head cross attention layer; and
project the learnable vector into the one or more inducing points in the query/key space to produce the axis of the query/key space,
wherein the axis is used to match one or more keys of the input entities with one or more inducing point keys of a closest inducing point of the one or more inducing points to arrange and quantize the input entities along the axis.

18. A non-transitory computer-readable storage medium carrying one or more sequences of one or more instructions which, when executed by one or more processors, cause an apparatus to perform:
creating a sort convolutional neural network (SortCNN) layer comprising a multi-head cross-attention layer and one or more convolutional neural network (CNN) layers, wherein at least one attention head of the multi-head cross-attention layer is associated with at least one linear projection matrix that is trained to arrange and quantize an unsorted set of input entities along an axis of a query/key space into a soft sorted set of the input entities based on one or more inducing points in the query/key space; and
projecting the set of soft sorted entities from the multi-head cross-attention layer through the CNN layers,
wherein the CNN layers learn one or more functions based on integrating information from the set of soft sorted entities as arranged and quantized by the at least one linear projection matrix.

19. The non-transitory computer-readable storage medium of claim 18, wherein the multi-head cross-attention layer takes in the input entities and one or more queries to generate an output entity for each query of the one or more queries, and wherein the output entity is a weighted linear combination of the input entities based on a matching of one or more keys of the input entities to each query.

20. The non-transitory computer-readable storage medium of claim 19, wherein a dimensionality of the query/key space is based on a dimensionality of the one or more queries and the one or more keys of the input entities, and wherein the axis corresponds to one dimension of the query/key space.
